(19) United States
(12) Patent Application Publication
(10) Pub. No.: US 2003/0012727 A1
(43) Pub. Date: Jan. 16, 2003

(54) Barium titanate powder, method for manufacturing and evaluating the same, dielectric ceramic, and monolithic ceramic capacitor

(76) Inventors: Yuji Yoshikawa, Hikone-shi (JP); Yasunari Nakamura, Shiga-ken (JP); Masami Yabuuchi, Yokaichi-shi (JP)

Correspondence Address: DICKSTEIN SHAPIRO MORIN & OSHINSKY LLP, Edward A. Meilman, 41st Floor, 1177 Avenue of the Americas, New York, NY, 10036-2714, US

(21) Appl. No.: 10/173,665

(22) Filed: Jun. 19, 2002

(30) Foreign Application Priority Data
Jun. 19, 2001 (JP) 2001-184298

(51) Int. Cl. C01G 23/00

(52) U.S. Cl. 423/598

(57) ABSTRACT

A barium carbonate powder having a specific surface area of at least about 20 m²/g is mixed with a titanium oxide powder to form a powder mixture. The titanium oxide powder has such a specific surface area that the specific surface area ratio of the titanium oxide powder to the barium carbonate powder is at least about 1. The powder mixture is calcined and thus results in a fine barium titanate powder having a high content of tetragonal crystals and a small range of compositional variation.

### BACKGROUND OF THE INVENTION

1. Field of the Invention

The present invention relates to a method for manufacturing a barium titanate powder and a method for evaluating the resulting barium titanate powder, the resulting barium titanate powder itself, a dielectric ceramic, and a monolithic ceramic capacitor. In particular, the present invention relates to an improved method for preparing by solid-phase reaction a much finer barium titanate powder having a high content of tetragonal crystals.

2. Description of the Related Art

Sintering a powder material mainly containing barium titanate powder results in a dielectric ceramic. The dielectric ceramic is used, for example, for forming dielectric ceramic layers of a monolithic ceramic capacitor.

A method used to miniaturize the monolithic ceramic capacitor and provide it with high capacitance is effective to form thinner dielectric ceramic layers. In order to form such thin dielectric ceramic layers, the barium titanate powder used for the dielectric ceramic layers must be made finer and have a small range of compositional variation. In other words, the barium titanate powder needs to be uniform, and barium titanate which is a constituent of the powder needs to contain a high proportion of tetragonal crystals.

Hydrothermal synthesis and hydrolysis have been suggested and put to practical use to readily obtain fine, uniform barium titanate powders, but these methods increase the cost of manufacturing the barium titanate powders. Accordingly, the solid-phase reaction has traditionally been applied to manufacturing barium titanate powders.

In the solid-phase reaction method, the starting materials, for example, a barium carbonate powder and a titanium oxide powder, are mixed with each other and are then calcined. For manufacturing finer and more uniform barium titanate powder by the solid-phase reaction, it is most important to make the barium carbonate powder and titanium oxide powder as fine as possible and to disperse these powders uniformly. For this purpose, the barium carbonate powder and the titanium oxide powder may be, for example, mechanically pulverized and dispersed in a suitable medium. Unfortunately, such pulverization and dispersion are not satisfactory.

Japanese Unexamined Patent Application Publication No. 10-338524 discloses that by using a barium carbonate powder having a specific surface area of 10 m²/g or less and a titanium oxide powder having a specific surface area of 15 m²/g or more, a barium titanate powder having a small dispersion of grain sizes can be efficiently obtained by the solid-phase reaction method. However, the inventors have found that using a barium carbonate having a specific surface area of less than 20 m²/g leads to an increased mean grain size of the barium titanate powder, and therefore, the barium titanate powder cannot have a high content of tetragonal crystals and also a small range of compositional variation.

Also, the mean grain size of the barium titanate powder is increased even with a barium carbonate powder having a specific surface area of 20 m²/g or more, depending on the specific surface area of the titanium oxide powder, and therefore, the barium titanate powder cannot necessarily have a high content of tetragonal crystals and a small range of compositional variation.

### SUMMARY OF THE INVENTION

Accordingly, an object of the present invention is to provide a method for constantly manufacturing a barium titanate powder having a high content of tetragonal crystals and a small range of compositional variation by solid-phase reaction and to provide a barium titanate powder manufactured by the method.

Another object of the present invention is to provide a method for determining, with high reliability, whether the barium titanate powder can be used for monolithic ceramic capacitors.

Still another object of the present invention is to provide a dielectric ceramic prepared by sintering the barium titanate powder and a monolithic ceramic capacitor comprising the dielectric ceramic.

The present invention is directed to a method for manufacturing a barium titanate powder. The method includes the steps of mixing a barium carbonate powder and a titanium oxide powder to form a powder mixture and calcining the powder mixture.

The barium carbonate powder has a specific surface area of at least about 20 m²/g as measured by the BET method, and the titanium oxide powder has such a specific surface area that the specific surface area ratio of the titanium oxide powder to the barium carbonate powder is at least about 1.

The present invention is also directed to a method for manufacturing a barium titanate powder including the steps of employing a barium carbonate powder has a specific surface area of at least about 20 m²/g as measured by the BET method; employing a titanium oxide powder has such a specific surface area that the specific surface area ratio of the titanium oxide to the barium carbonate is at least about 1 as measured by the BET method; mixing the barium carbonate powder and the titanium oxide powder to form a powder mixture; and calcining the powder mixture.

The present invention is also directed to a barium titanate powder manufactured by the method described above. The barium titanate powder contains barium titanate having a c/a crystallographic axial ratio of at least about 1.008 and having a dispersion of Ba/Ti molar ratios of about 0.01 or less as determined by TEM-EDX analysis when the number of samples is 10. The specific surface area of the barium titanate powder is at least about 5 m²/g as measured by the BET method.

The dispersion represents the difference between the maximum Ba/Ti molar ratio and the minimum Ba/Ti molar ratio when the primary particles of 10 barium titanate powder samples are measured by the TEM-EDX analysis.

The present invention is also directed to a method for evaluating a barium titanate powder to determine its suitability for dielectric use. The method includes the steps of measuring the specific surface area of the barium titanate powder by the BET method; determining the c/a crystallographic axial ratio of the barium titanate of the barium titanate powder; determining the dispersion of Ba/Ti molar ratio of the barium titanate by TEM-EDX analysis; and determining whether the specific surface area is at least about 5 m²/g, the c/a crystallographic axial ratio is at least about 1.008; and the dispersion of Ba/Ti molar ratios is about 0.01 or less when the number of samples is 10.

The present invention is also directed to a dielectric ceramic comprising a barium titanate powder prepared by the method described above. The powder material is sintered.

The present invention is also directed to a monolithic ceramic capacitor. The monolithic ceramic capacitor comprises dielectric ceramic layers comprising the above-described dielectric ceramic. Internal electrodes extend along predetermined interfaces between the dielectric ceramic layers. Two opposing internal electrodes separated by one of the dielectric ceramic layers define a capacitor.

### BRIEF DESCRIPTION OF THE DRAWING

FIG. 1 is a schematic sectional view showing an internal structure of a monolithic ceramic capacitor of the present invention.

### DESCRIPTION OF THE PREFERRED EMBODIMENTS

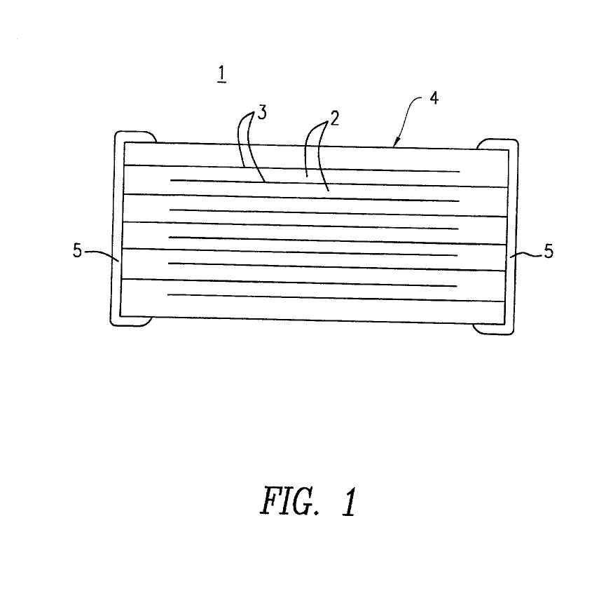

FIG. 1 is a schematic sectional view showing an internal structure of a monolithic ceramic capacitor 1 of the present invention.

The monolithic ceramic capacitor 1 comprises a laminate 4 having a plurality of laminated dielectric ceramic layers 2 and a plurality of internal electrodes 3 extending along a part of interfaces of the dielectric ceramic layers 2. The internal electrodes 3 are disposed so that two opposing internal electrodes 3 separated by a dielectric ceramic layer 2 form a capacitor.

External electrodes 5, which serve as terminal electrodes, are formed on both ends of the laminate 4 and each external electrode 5 is electrically connected with alternate internal electrodes 3; hence, the internal electrodes 3 are disposed in the laminating direction so as to be alternately connected with one external electrode 5 and the other external electrode 5.

A dielectric ceramic forming the dielectric ceramic layers 2 is prepared by sintering a powder material mainly containing a barium titanate powder prepared according to the present invention.

The barium titanate powder is prepared by mixing barium carbonate powder and titanium oxide powder and by calcining the mixture to effect a solid-phase reaction. The resulting barium titanate powder may be pulverized if necessary.

Specifically, the barium carbonate to be mixed has a specific surface area of about 20 m²/g or more as measured by the BET (Brunauer-Emmett-Teller) method. It is, therefore, necessary that the specific surface area of the barium carbonate powder used for preparing the barium titanate powder is at least about 20 m²/g as measured by the BET method.

On the other hand, the titanium oxide powder to be mixed has such a specific surface area that the specific surface area ratio to the barium carbonate powder is at least about 1. In this instance, it is necessary to determine both the specific surface areas of the barium carbonate powder and the titanium oxide powder according to the BET method to be sure that the specific surface area ratio of the titanium oxide powder to the barium carbonate powder is at least about 1.

The barium carbonate powder and the titanium oxide powder are mixed with each other such that, typically, the Ba/Ti molar ratio is about 1, and thus results in a powder mixture. For preparing the powder mixture, for example, wet blending may be applied. In this instance, the powder mixture is dried before use in the following process.

Next, the powder mixture is heated, for example, at 1100° C. for 2 hours in a batch furnace in order to become calcined. Thus, barium titanate is synthesized and the barium titanate can be pulverized by a dry pulverizer to result in a barium titanate powder.

As described above, when a barium carbonate powder having a specific surface area of at least about 20 m²/g is used for preparing a barium titanate powder, a titanium oxide powder is selected such that the specific surface area ratio of the titanium oxide powder to the barium carbonate powder is at least about 1. Consequently, the particles are prevented from growing abnormally and the content of tetragonal crystals becomes high in the resulting barium titanate powder, and thus the particle size distribution and the compositional variation are reduced.

More specifically, the barium titanate powder has a specific surface area of about 5 m²/g or more as measured by the BET method. The barium titanate constituting the barium titanate powder has a c/a axial ratio of about 1.008 or more, which represents the ratio of the c axis to the a axis of the crystal lattice, and the dispersion of Ba/Ti molar ratios representing a compositional variation of the barium titanate is about 0.01 or less as measured by transmission electron microscopy and energy dispersive x-ray spectroscopy (TEM-EDX) analysis when the number of samples is 10.

Next, the barium titanate powder and a powder material mainly containing the barium titanate powder are kneaded with a binder and a vehicle containing a solvent to form a slurry. This slurry is formed into a sheet, thus resulting in ceramic green sheets. The ceramic green sheets are each provided with an internal electrode 3 thereon, as shown in FIG. 1, and are then laminated to form a green laminate. The green laminate results in the laminate 4 shown in FIG. 1 after being sintered.

Then, the external electrodes 5 are disposed on the outer surfaces of the laminate 4 and thus the monolithic ceramic capacitor 1 is completed. The dielectric ceramic layers 2 included in the laminate 4 of the monolithic ceramic capacitor 1 are formed by sintering the ceramic green sheets. In other words, the monolithic ceramic capacitor 1 comprises the dielectric ceramic formed by sintering the powder material mainly containing the barium titanate powder prepared in accordance with the procedure described above.

The above-described characteristics of the barium titanate powder, that is, the specific surface area of about 5 m²/g or more, the c/a axial ratio of about 1.008 or more, and the dispersion of Ba/Ti molar ratios of about 0.01 or less are advantageous in making the dielectric ceramic layers 2 thinner.

It is, therefore, suggested that the resulting barium titanate powder is examined, before use, to see whether it is suitable to form thinner dielectric ceramic layers 2 for a miniaturized large-capacitance capacitor. The specific surface area of the barium titanate powder is measured by the BET method and the c/a crystallographic axial ratio of barium titanate constituting the powder is also determined. Also, the dispersion of the Ba/Ti molar ratios is determined by TEM-EDX analysis to determine the compositional variation of the barium titanate. The barium titanate powder is suitable when it has a specific surface area of about 5 m²/g, the barium titanate crystals have a c/a axial ratio of about 1.008 or more, and that the dispersion of Ba/Ti molar ratios is about 0.01 or less when the number of samples is 10.

Examples for verifying the advantages of the method for manufacturing the barium titanate powder according to the present invention will now be described.

First, a barium carbonate (BaCO₃) powder and a titanium oxide (TiO₂) powder, each having the specific surface area shown in Table 1, are weighed and wet-blended such that the Ba/Ti molar ratio is 1.000. After being dried, the powder mixture is calcined at the temperature shown in Table 1 for 2 hours in a batch furnace.

TABLE 1

| | |
|---|---|
| Specific surface area (m²/g) | Temperature |

| Sample | BaCO₃ powder | TiO₂ powder | (° C.) |
|---|---|---|---|
| 1 | 21.3 | 21.4 | 1100 |
| 2 | 25.6 | 52.3 | 1100 |
| *3 | 21.3 | 10.1 | 1000 |
| *4 | 11.3 | 18.5 | 1000 |
| *5 | 11.3 | 2.9 | 1000 |

Next, the calcined powder is pulverized by a dry pulverizer and thus results in a barium titanate powder.

Table 2 shows the specific surface area of the barium titanate powder as measured by the BET method, the c/a axial ratio of the barium titanate crystals constituting the barium titanate powder, and the dispersion of Ba/Ti molar ratios as determined by the TEM-EDX analysis when the number of samples is 10.

TABLE 2

| | Specific surface area | | Ba/Ti molar ratio |
|---|---|---|---|
| Sample | (m²/g) | c/a axial ratio | dispersion |
| 1 | 5.1 | 1.0090 | 0.007 |
| 2 | 6.3 | 1.0085 | 0.005 |
| *3 | 4.0 | 1.0070 | 0.025 |
| *4 | 3.5 | 1.0072 | 0.022 |
| *5 | 2.0 | 1.0065 | 0.033 |

The samples designated by the * symbol in Tables 1 and 2 are comparative samples without the scope of the present invention.

As shown in Tables 1 and 2, samples 1 and 2 are within the scope of the present invention. Specifically, the specific surface areas of the BaCO₃ powders in samples 1 and 2 are at least 20 m²/g and the specific surface area ratios of the TiO₂ powders to the BaCO₃ powders are at least about 1. The resulting barium titanate powders of samples 1 and 2 had specific surface areas of about 5 m²/g or more, c/a axial ratios of about 1.008 or more, and dispersions of Ba/Ti molar ratios of about 0.01 or less; hence, fine barium titanate powders having a high content of tetragonal crystals and a small range of compositional variation were obtained.

In particular, sample 2, in which a high specific surface area ratio of TiO₂ to BaCO₃ was 2 or more, resulted in a fine barium titanate powder having a smaller range of compositional variation in comparison with sample 1.

In contrast, sample 3, in which the BaCO₃ powder had a specific surface area of more than 20 m²/g but a specific surface area ratio of TiO₂ to BaCO₃ of less than about 1, resulted in a barium titanate powder having a specific surface area of less than about 5 m²/g, a c/a axial ratio of less than about 1.008, and a dispersion of Ba/Ti molar ratios of more than about 0.01. Hence, even a BaCO₃ powder having a specific surface area of about 20 m²/g did not result in a fine barium titanate powder having a high content of tetragonal crystals and a small range of compositional variation.

Also, samples 4 and 5, in which the BaCO₃ powders had specific surface areas of less than 20 m²/g, resulted in barium titanate powders having specific surface areas of less than about 5 m²/g, c/a axial ratios of less than about 1.008, and dispersions of Ba/Ti molar ratios of more than about 0.01 irrespective of the value of the specific surface area of TiO₂. Hence, samples 3 and 4 did not result in fine barium titanate powders having a high content of tetragonal crystals and a small range of compositional variation like with sample 3.

By using a barium carbonate powder having a specific surface area of at least 20 m²/g and a titanium oxide powder having such a specific surface area that the specific surface area ratio of the titanium oxide powder to the barium carbonate powder is at least about 1 to prepare a barium titanate powder according to the present invention, the barium titanate particles can be prevented from growing abnormally and the content of tetragonal crystals of the barium titanate becomes high, as described above. Thus, the resulting barium titanate powder can have a specific surface area of at least about 5 m²/g, a c/a axial ratio of at least about 1.008, and a compositional variation index, that is, a dispersion (variation) of Ba/Ti molar ratios, of about 0.01 or less.

The resulting monolithic ceramic capacitor comprising dielectric ceramic layers formed of the dielectric ceramic prepared by sintering a powder material mainly containing the barium titanate powder according to the present invention, therefore, can ensure the reliability thereof even though the dielectric ceramic layers become thinner to achieve a miniaturized and large-capacitance monolithic ceramic capacitor.

Also, because a solid-phase reaction to the preparation of the barium titanate powder is used according to the present invention, the barium titanate powder can be manufactured at a lower cost in comparison with hydrothermal synthesis and hydrolysis.

In addition, by ensuring that the resulting barium titanate powder has a specific surface area of about 5 m²/g or more, a c/a axial ratio of about 1.008 or more, and a dispersion of Ba/Ti molar ratios of about 0.01 or less when the number of samples is 10, the characteristics of the barium titanate powder advantageous to thinner dielectric ceramic layers can be achieved and thus a miniaturized and large-capacitance monolithic ceramic capacitor can be achieved. Consequently, the process yields of the barium titanate powder and the monolithic ceramic capacitor can be improved.

What is claimed is:

1. A method for manufacturing a barium titanate powder comprising:
mixing a barium carbonate powder and a titanium oxide powder to form a powder mixture; and
calcining the powder mixture,
wherein the barium carbonate powder has a specific surface area of at least about 20 m²/g as measured by the BET method and the specific surface area ratio of the titanium oxide powder to the barium carbonate powder is at least about 1.

2. A method for manufacturing a barium titanate powder according to claim 1, further comprising
providing a barium carbonate which has a specific surface area of at least about 20 m²/g as measured by the BET method; and
providing a titanium oxide powder which has a specific surface area such that the specific surface area ratio of the titanium oxide powder to the barium carbonate powder is at least about 1 as measured by the BET method.

3. A method for manufacturing a barium titanate powder according to claim 2, wherein the provided titanium oxide powder has a specific surface area which is greater than the specific surface area of the barium carbonate powder.

4. A method for manufacturing a barium titanate powder according to claim 3, wherein the provided titanium oxide powder has a specific surface area such that the specific surface area ratio of the titanium oxide powder to the barium carbonate powder is at least 2 as measured by the BET method.

5. A method for manufacturing a barium titanate powder according to claim 1, wherein the provided titanium oxide powder has a specific surface area which is greater than the specific surface area of the barium carbonate powder.

6. A method for manufacturing a barium titanate powder according to claim 5, wherein the titanium oxide powder has a specific surface area such that the specific surface area ratio of the titanium oxide powder to the barium carbonate powder is at least 2 as measured by the BET method.

7. A barium titanate powder obtainable by the manufacturing method as set forth in claim 1, comprising:
a barium titanate having a c/a crystallographic axial ratio of at least about 1.008, a dispersion of Ba/Ti molar ratios of about 0.01 or less as determined by TEM-EDX analysis when the number of samples is 10, and a BET specific surface area of at least about 5 m²/g.

8. A barium titanate powder as set forth in claim 7, wherein the dispersion of Ba/Ti molar ratios is 0.007 or less.

9. A barium titanate powder as set forth in claim 8, wherein the c/a crystallographic axial ratio of at least 1.0085, and the BET specific surface area is at least 5.1 m²/g.

10. A sintered barium titanate powder according to claim 9.

11. A sintered barium titanate powder according to claim 8.

12. A sintered barium titanate powder according to claim 7.

13. A monolithic ceramic capacitor comprising:
a plurality of dielectric ceramic layers comprising a dielectric ceramic as set forth in claim 12; and
at least one pair of internal electrodes each of which extends along an interface between dielectric ceramic layers, wherein the two opposing internal electrodes in the pair separated by dielectric ceramic to define a capacitor.

14. A monolithic ceramic capacitor comprising:
a plurality of dielectric ceramic layers comprising a dielectric ceramic as set forth in claim 11; and
at least one pair of internal electrodes each of which extends along an interface between dielectric ceramic layers, wherein the two opposing internal electrodes in the pair separated by dielectric ceramic to define a capacitor.

15. A monolithic ceramic capacitor comprising:
a plurality of dielectric ceramic layers comprising a dielectric ceramic as set forth in claim 10; and
at least one pair of internal electrodes each of which extends along an interface between dielectric ceramic layers, wherein the two opposing internal electrodes in the pair separated by dielectric ceramic to define a capacitor.

16. A method for evaluating a barium titanate powder for suitability for the production of thin dielectric ceramics, comprising:
determining the specific surface area of the barium titanate powder by the BET method;
determining the c/a crystallographic axial ratio of barium titanate of the barium titanate powder;
determining the dispersion of Ba/Ti molar ratios of the barium titanate by TEM-EDX analysis; and
determining whether the specific surface area is at least about 5 m²/g, the c/a crystallographic axial ratio is at least about 1.008; and the dispersion of Ba/Ti molar ratios is about 0.01 or less when the number of samples is 10.
